(19) United States
(12) Patent Application Publication
(10) Pub. No.: US 2024/0310192 A1
(43) Pub. Date: Sep. 19, 2024

(54) OPTICAL FIBER STATE MEASURING DEVICE AND OPTICAL FIBER STATE MEASURING METHOD

(71) Applicant: NIPPON TELEGRAPH AND TELEPHONE CORPORATION, Tokyo (JP)

(72) Inventor: Chihiro KITO, Musashino-Shi, Tokyo (JP)

(73) Assignee: NIPPON TELEGRAPH AND TELEPHONE CORPORATION, Tokyo (JP)

(21) Appl. No.: 18/576,031

(22) PCT Filed: Jul. 15, 2021
(86) PCT No.: PCT/JP2021/026691

§ 371 Date: Jan. 2, 2024

(51) Int. Cl. G01D 5/353

(52) U.S. Cl. CPC G01D 5/35364

(57) ABSTRACT

In the present disclosure, a direction of a change ΔBFS in a Brillouin frequency shift amount of an optical fiber to be measured M from a steady state or a non-application state to the non-steady state or the application state is detected as is determined as one of a positive direction and a negative direction based on first beat frequencies ΔR1 and ΔR1′ and second beat frequencies ΔR2 and ΔR2′ between Brillouin frequency shift amounts BFS_{M} and BFS_{M}′ of the optical fiber to be measured M and constant Brillouin frequency shift amounts BFS_{R1} and BFS_{R2} of a first reference optical fiber 7 and a second reference optical fiber 9 in the steady state of temperature or the non-application state of strain or vibration and in the non-steady state of temperature or the application state of strain or vibration.

### TECHNICAL FIELD

The present disclosure relates to a technique for measuring temperature, strain, or vibration of an optical fiber to be measured.

### BACKGROUND ART

Patent Literature 1 and the like disclose a technique for measuring temperature, strain, or vibration of an optical fiber to be measured based on a Brillouin frequency shift amount of the optical fiber to be measured.

In a general technique, a change in the Brillouin frequency shift amount of an optical fiber to be measured from a steady state or a non-application state to a non-steady state or an application state is detected based on the Brillouin frequency shift amount of the optical fiber to be measured in the steady state of temperature or the non-application state of strain or vibration and in the non-steady state of temperature or the application state of strain or vibration. Here, since the Brillouin frequency shift amount of the optical fiber to be measured is on the order of 10 GHZ, a wideband light receiving device is required, and the device configuration of the optical fiber state measurement becomes complicated.

In Patent Literature 1, a change in the Brillouin frequency shift amount of the optical fiber to be measured from the steady state or the non-application state to the non-steady state or the application state is detected based on a beat frequency between the Brillouin frequency shift amount of the optical fiber to be measured and the constant Brillouin frequency shift amount of the reference optical fiber in the steady state of temperature or the non-application state of strain or vibration and in the non-steady state of temperature or the application state of strain or vibration. Here, since the beat frequency between the two Brillouin frequency shift amounts is on the order of 100 MHZ, a wideband light receiving device becomes unnecessary, and the device configuration of the optical fiber state measurement is simplified.

### CITATION LIST

### Non Patent Literature

Non Patent Literature 1: Daisuke Iida and Fumihiko Ito, “Low bandwidth temperature sensing using reference stimulated Brillouin scattered beam”, IEICE technical report, The Institute of Electronics, Information and Communication Engineers, OFT2008-43, vol. 108, no. 245, pp. 45-50, 2008.

### SUMMARY OF INVENTION

### Technical Problem

In Patent Literature 1, the beat frequency between two Brillouin frequency shift amounts indicates the absolute value of the difference between the two Brillouin frequency shift amounts, and does not indicate the sign of the difference between the two Brillouin frequency shift amounts. Therefore, it is possible to detect a magnitude of a change in the Brillouin frequency shift amount of the optical fiber to be measured from the steady state of the temperature or the non-application state of the strain or vibration to the non-steady state of the temperature or the application state of the strain or vibration, but it is not possible to detect a direction of a change in the Brillouin frequency shift amount of the optical fiber to be measured.

Therefore, in order to solve the above problems, an object of the present disclosure is to eliminate the need for a wideband light receiving device, simplify a device configuration of optical fiber state measurement, and detect a direction and magnitude of a change in a Brillouin frequency shift amount of an optical fiber to be measured from a steady state of temperature or a non-application state of strain or vibration to a non-steady state of temperature or an application state of strain or vibration.

### Solution to Problem

In order to solve the above problem, the direction of a change in the Brillouin frequency shift amount of the optical fiber to be measured from the steady state or the non-application state to the non-steady state or the application state is determined as “one of the positive direction and the negative direction” based on “two or more types” of beat frequencies between the Brillouin frequency shift amount of the optical fiber to be measured and the constant Brillouin frequency shift amount of the “two or more” reference optical fibers in the steady state of temperature or the non-application state of strain or vibration and in the non-steady state of temperature or the application state of strain or vibration.

Specifically, according to the present disclosure, there is provided an optical fiber state measurement device that measures temperature, strain, or vibration of an optical fiber to be measured, the optical fiber state measurement device including: a first reference optical fiber and a second reference optical fiber that have an optical fiber length longer than that of the optical fiber to be measured, have a constant Brillouin frequency shift amount different from that of the optical fiber to be measured in a steady state of temperature or a non-application state of strain or vibration with respect to the same incident wavelength, and have constant Brillouin frequency shift amounts different from each other with respect to the same incident wavelength; a test light incidence unit that causes pulsed measurement test light to be incident on the optical fiber to be measured, and causes continuous light having the same wavelength as the measurement test light or pulsed first reference test light and pulsed second reference test light to be incident on the first reference optical fiber and the second reference optical fiber; a scattered light input unit into which pulsed measurement Brillouin scattered light is input from the optical fiber to be measured, and into which continuous light or pulsed first reference Brillouin scattered light and second reference Brillouin scattered light are input from the first reference optical fiber and the second reference optical fiber; a beat frequency detection unit that multiplexes the measurement Brillouin scattered light and the first reference Brillouin scattered light to detect a first beat frequency thereof, and multiplexes the measurement Brillouin scattered light and the second reference Brillouin scattered light to detect a second beat frequency thereof; and a shift amount change detection unit that detects a direction, that is, a sign, of a change in a Brillouin frequency shift amount of the optical fiber to be measured from the steady state or the non-application state to the non-steady state or the application state based on the first beat frequency and the second beat frequency in a steady state of a temperature or a non-application state of strain or vibration of the optical fiber to be measured and in a non-steady state of a temperature or an application state of strain or vibration of the optical fiber to be measured.

In addition, according to the present disclosure, there is provided an optical fiber state measurement method for measuring temperature, strain, or vibration of an optical fiber to be measured, the optical fiber state measurement method including, in order: by using a first reference optical fiber and a second reference optical fiber that have an optical fiber length longer than that of the optical fiber to be measured, have a constant Brillouin frequency shift amount different from that of the optical fiber to be measured in a steady state of temperature or a non-application state of strain or vibration with respect to the same incident wavelength, and have constant Brillouin frequency shift amounts different from each other with respect to the same incident wavelength, a test light incidence step of causing pulsed measurement test light to be incident on the optical fiber to be measured, and causing continuous light having the same wavelength as the measurement test light or pulsed first reference test light and pulsed second reference test light to be incident on the first reference optical fiber and the second reference optical fiber; a scattered light input step in which pulsed measurement Brillouin scattered light is input from the optical fiber to be measured, and continuous light or pulsed first reference Brillouin scattered light and second reference Brillouin scattered light are input from the first reference optical fiber and the second reference optical fiber; a beat frequency detection step of multiplexing the measurement Brillouin scattered light and the first reference Brillouin scattered light to detect a first beat frequency thereof, and multiplexing the measurement Brillouin scattered light and the second reference Brillouin scattered light to detect a second beat frequency thereof; and a shift amount change detection step of detecting a direction, that is, a sign, of a change in a Brillouin frequency shift amount of the optical fiber to be measured from the steady state or the non-application state to the non-steady state or the application state based on the first beat frequency and the second beat frequency in a steady state of a temperature or a non-application state of strain or vibration of the optical fiber to be measured and in a non-steady state of a temperature or an application state of strain or vibration of the optical fiber to be measured.

According to this configuration, it is possible to eliminate the need for a wideband light receiving device, simplify a device configuration of optical fiber state measurement, and detect a direction, that is, a sign, of the change in the Brillouin frequency shift amount of the optical fiber to be measured from the steady state of temperature or the non-application state of strain or vibration to the non-steady state of temperature or the application state of strain or vibration.

In addition, the present disclosure provides the optical fiber state measurement device in which the shift amount change detection unit detects a direction of a change in a Brillouin frequency shift amount of the optical fiber to be measured from the steady state or the non-application state to the non-steady state or the application state based on a direction of a change in the first beat frequency and a direction of a change in the second beat frequency from the steady state or the non-application state to the non-steady state or the application state.

According to this configuration, it is possible to easily detect the direction, that is, the sign, of the change in the Brillouin frequency shift amount of the optical fiber to be measured based on the direction, that is, the sign (regardless of the magnitude, that is, the absolute value), of the change in two or more types of beat frequencies from the steady state of temperature or the non-application state of strain or vibration to the non-steady state of temperature or the application state of strain or vibration.

In addition, the present disclosure provides the optical fiber state measurement device, in which, when a direction of a change cannot be determined above, the shift amount change detection unit determines a direction of a change in a Brillouin frequency shift amount of the optical fiber to be measured from the steady state or the non-application state to the non-steady state or the application state based on a magnitude relationship between the first beat frequency and the second beat frequency in the non-steady state or the application state.

According to this configuration, when determination using the direction, that is, the sign, of the change in the two or more types of beat frequencies described above is not possible, it is possible to reliably determine the direction, that is, the sign, of the change in the Brillouin frequency shift amount of the optical fiber to be measured based on the magnitude relationship (regardless of the absolute value of each frequency) between the two or more types of beat frequencies in the non-steady state of temperature or the application state of strain or vibration.

In addition, the present disclosure provides the optical fiber state measurement device in which the shift amount change detection unit detects a magnitude, that is, an absolute value, of a change in a Brillouin frequency shift amount of the optical fiber to be measured from the steady state or the non-application state to the non-steady state or the application state based on the first beat frequency and the second beat frequency in the steady state or the non-application state and in the non-steady state or the application state.

According to this configuration, it is possible to eliminate the need for a wideband light receiving device, simplify a device configuration of optical fiber state measurement, and detect a magnitude, that is, the absolute value, of the change in the Brillouin frequency shift amount of the optical fiber to be measured from the steady state of temperature or the non-application state of strain or vibration to the non-steady state of temperature or the application state of strain or vibration.

In addition, the present disclosure provides the optical fiber state measurement device, in which constant Brillouin frequency shift amounts of the first reference optical fiber and the second reference optical fiber, which are different from each other, are separated from each other by a Brillouin gain bandwidth or more as compared with a Brillouin frequency shift amount of the optical fiber to be measured in the steady state or the non-application state.

According to this configuration, any beat frequency is less likely to fall to the baseband frequency, and thus can be detected in the order of 100 MHZ or 10 MHZ. Here, it is possible to detect the amount of change in the wide range of Brillouin frequency shift amounts as the amount of change in the Brillouin frequency shift amount of the optical fiber to be measured from the steady state of the temperature or the non-application state of the strain or vibration to the non-steady state of the temperature or the application state of the strain or vibration.

In addition, the present disclosure provides the optical fiber state measurement device, in which, when clear measurement of the first beat frequency or the second beat frequency is not possible in the non-steady state or the application state, the shift amount change detection unit uses a third reference optical fiber having a Brillouin frequency shift amount in the steady state or the non-application state of the optical fiber to be measured and a constant Brillouin frequency shift amount different from constant Brillouin frequency shift amounts of the first reference optical fiber and the second reference optical fiber, which are different from each other.

According to this configuration, even when any beat frequency falls to the baseband frequency, the beat frequency in place of the beat frequency is less likely to fall to the baseband frequency, and thus can be detected in the order of 100 MHz or 10 MHz. Here, it is possible to detect the amount of change in the wide range of Brillouin frequency shift amounts as the amount of change in the Brillouin frequency shift amount of the optical fiber to be measured from the steady state of the temperature or the non-application state of the strain or vibration to the non-steady state of the temperature or the application state of the strain or vibration.

### Advantageous Effects of Invention

As described above, according to the present disclosure, it is possible to eliminate the need for a wideband light receiving device, simplify a device configuration of optical fiber state measurement, and detect a direction and magnitude of a change in a Brillouin frequency shift amount of an optical fiber to be measured from a steady state of temperature or a non-application state of strain or vibration to a non-steady state of temperature or an application state of strain or vibration.

### BRIEF DESCRIPTION OF DRAWINGS

FIG. 1 is a diagram illustrating a configuration of an optical fiber state measurement device of the present disclosure.

FIG. 2 is a diagram illustrating a procedure of optical fiber state measurement processing according to the present disclosure.

FIG. 3 is a diagram illustrating a specific example of the optical fiber state measurement processing according to a first embodiment.

FIG. 4 is a diagram illustrating a specific example of the optical fiber state measurement processing according to the first embodiment.

FIG. 5 is a diagram illustrating a specific example of optical fiber state measurement processing according to a second embodiment.

FIG. 6 is a diagram illustrating a specific example of the optical fiber state measurement processing according to the second embodiment.

FIG. 7 is a diagram illustrating Brillouin frequency shift amounts of first and second reference optical fibers.

FIG. 8 is a diagram illustrating Brillouin frequency shift amounts of a third reference optical fiber.

### DESCRIPTION OF EMBODIMENTS

Embodiments of the present disclosure will be described with reference to the accompanying drawings. The embodiments to be described below are examples carried out in the present disclosure, and the present disclosure is not limited to the following embodiments.

### (Configuration of Optical Fiber State Measurement Device of Present Disclosure)

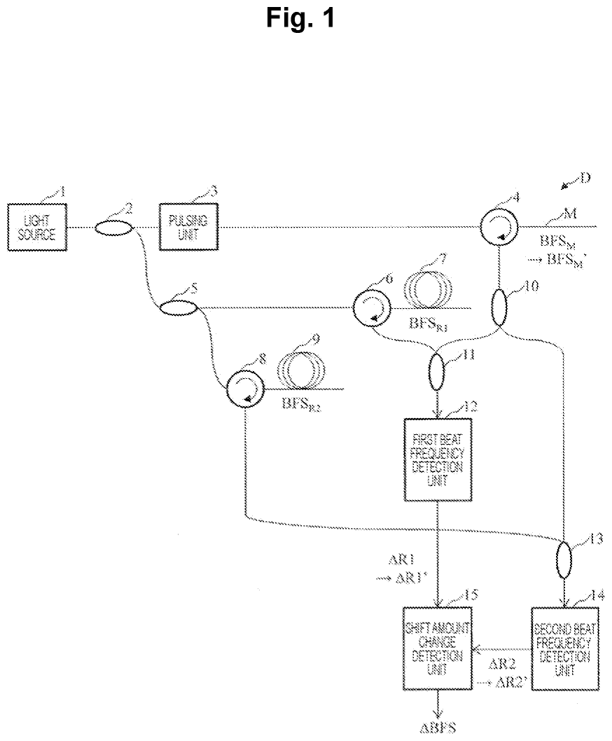

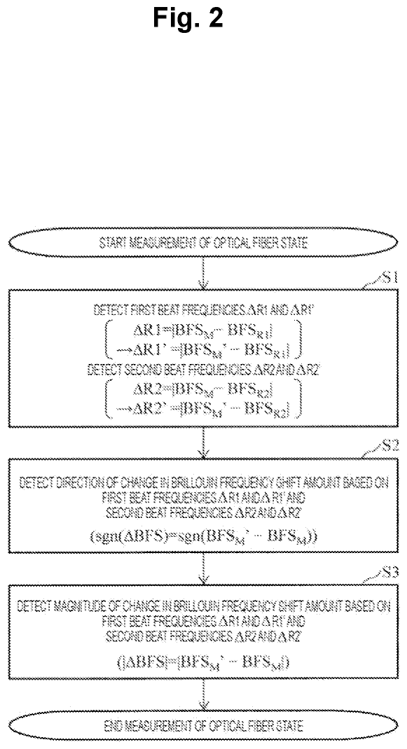

FIG. 1 illustrates a configuration of an optical fiber state measurement device of the present disclosure. FIG. 2 illustrates a procedure of the optical fiber state measurement processing of the present disclosure. An optical fiber state measurement device D measures the temperature, strain, or vibration of an optical fiber to be measured M using Brillouin optical time domain reflectometry (BOTDR).

The optical fiber state measurement device D includes a light source 1, a branching unit 2, a pulsing unit 3, a circulator 4, a branching unit 5, a circulator 6, a first reference optical fiber 7, a circulator 8, a second reference optical fiber 9, a branching unit 10, a multiplexing unit 11, a first beat frequency detection unit 12, a multiplexing unit 13, a second beat frequency detection unit 14, and a shift amount change detection unit 15. The first beat frequency detection unit 12, the second beat frequency detection unit 14, and the shift amount change detection unit 15 can be implemented by installing an optical fiber state measurement program illustrated in FIG. 2 on a computer.

The first reference optical fiber 7 has an optical fiber length longer than that of the optical fiber to be measured M, and has a constant Brillouin frequency shift amount BFS_{R1} (≠the following BFS_{R2}) different from a Brillouin frequency shift amount BFS_{M} of the optical fiber to be measured M in a steady state of temperature or a non-application state of strain or vibration with respect to the same incident wavelength A. The second reference optical fiber 9 has an optical fiber length longer than that of the optical fiber to be measured M, and has a constant Brillouin frequency shift amount BFS_{R2} (≠ the above-described BFS_{R1}) different from the Brillouin frequency shift amount BFS_{M} of the optical fiber to be measured M in a steady state of temperature or a non-application state of strain or vibration with respect to the same incident wavelength λ.

The Brillouin frequency shift amount of the optical fiber to be measured M is BES in a steady state of temperature or a non-application state of strain or vibration, but changes to BFS_{M}′ in a non-steady state of temperature or an application state of strain or vibration. The constant Brillouin frequency shift amounts BFS_{R1} and BFS_{R2} of the first reference optical fiber 7 and the second reference optical fiber 9 may be set to a constant value by accommodating the first reference optical fiber 7 and the second reference optical fiber 9 in a temperature-adjustable thermostatic chamber, or may be set to a constant value by varying the materials of the first reference optical fiber 7 and the second reference optical fiber 9 and the distribution or type of the refractive index in the cross section.

The light source 1, the branching unit 2, the pulsing unit 3, and the circulator 4 cause pulsed measurement test light to enter the optical fiber to be measured M. The light source 1, the branching unit 2, the branching unit 5, and the circulator 6 cause continuous light or pulsed first reference test light having the same wavelength λ as the measurement test light to be incident on the first reference optical fiber 7. The light source 1, the branching unit 2, the branching unit 5, and the circulator 8 cause continuous light or pulsed second reference test light having the same wavelength λ as the measurement test light to be incident on the second reference optical fiber 9. High intensity Brillouin scattered light can be obtained by causing continuous light to be incident as the first reference test light and the second reference test light.

The pulsed measurement Brillouin scattered light is input into the circulator 4 and the branching unit 10 from the optical fiber to be measured M. The continuous light or pulsed first reference Brillouin scattered light is input into the circulator 6 from the first reference optical fiber 7. The continuous light or pulsed second reference Brillouin scattered light is input into the circulator 8 from the second reference optical fiber 9. By inputting continuous light as the first reference Brillouin scattered light and the second reference Brillouin scattered light, it is possible to obtain a Brillouin frequency shift amount with high accuracy.

The multiplexing unit 11 and the first beat frequency detection unit 12 multiplex the measurement Brillouin scattered light and the first reference Brillouin scattered light, and detect the first beat frequency between the measurement Brillouin scattered light and the first reference Brillouin scattered light (step S1). The first beat frequency between the measurement Brillouin scattered light and the first reference Brillouin scattered light is ΔR1=|BFS_{M}−BFS_{R1}| in a steady state of temperature or a non-application state of strain or vibration, but ΔR1′=|BFS_{M}′−BFS_{R1}| in a non-steady state of temperature or an application state of strain or vibration.

The multiplexing unit 13 and the second beat frequency detection unit 14 multiplex the measurement Brillouin scattered light and the second reference Brillouin scattered light, and detect the second beat frequency between the measurement Brillouin scattered light and the second reference Brillouin scattered light (step S1). The second beat frequency between the measurement Brillouin scattered light and the second reference Brillouin scattered light is ΔR2=|BFS_{M}−BFS_{R2}| in a steady state of temperature or a non-application state of strain or vibration, but ΔR2′=|BFS_{M}′−BFS_{R2}| in a non-steady state of temperature or an application state of strain or vibration.

The first beat frequency detection unit 12 and the second beat frequency detection unit 14 may be able to detect the first beat frequency and the second beat frequency once or more for one pulse of measurement Brillouin scattered light input at a delay time corresponding to a certain point of the optical fiber to be measured M.

The shift amount change detection unit 15 detects the direction, that is, the sign, of the change ΔBFS in the Brillouin frequency shift amount of the optical fiber to be measured M from the steady state or the non-application state to the non-steady state or the application state based on the first beat frequencies ΔR1 and ΔR1′ and the second beat frequencies ΔR2 and ΔR2′ in the steady state of temperature or the non-application state of strain or vibration and in the non-steady state of temperature or the application state of strain or vibration (step S2). The sign of the change ΔBFS in the Brillouin frequency shift amount of the optical fiber to be measured M is sgn (ΔBFS)=sgn(BFS_{M}′−BFS_{M}), and will be described in detail in the first and second embodiments.

As described above, it is possible to eliminate the need for a wideband light receiving device, simplify a device configuration of optical fiber state measurement, and detect the direction, that is, the sign, of the change ΔBFS in the Brillouin frequency shift amount of the optical fiber to be measured M from the steady state of temperature or the non-application state of strain or vibration to the non-steady state of temperature or the application state of strain or vibration.

The shift amount change detection unit 15 detects the magnitude, that is, the absolute value, of the change ΔBFS in the Brillouin frequency shift amount of the optical fiber to be measured M from the steady state or the non-application state to the non-steady state or the application state based on the first beat frequencies ΔR1 and ΔR1′ and the second beat frequencies ΔR2 and ΔR2′ in the steady state of temperature or the non-application state of strain or vibration and in the non-steady state of temperature or the application state of strain or vibration (step S3). The absolute value of the change ΔBFS in the Brillouin frequency shift amount of the optical fiber to be measured M is |ΔBFS|=|BFS_{M}′−BFS_{M}|, and will be described in detail in the first and second embodiments.

As described above, it is possible to eliminate the need for a wideband light receiving device, simplify a device configuration of optical fiber state measurement, and detect a magnitude, that is, the absolute value, of the change ΔBFS in the Brillouin frequency shift amount of the optical fiber to be measured M from the steady state of temperature or the non-application state of strain or vibration to the non-steady state of temperature or the application state of strain or vibration.

### (Specific Example of Optical Fiber State Measurement Processing of First Embodiment)

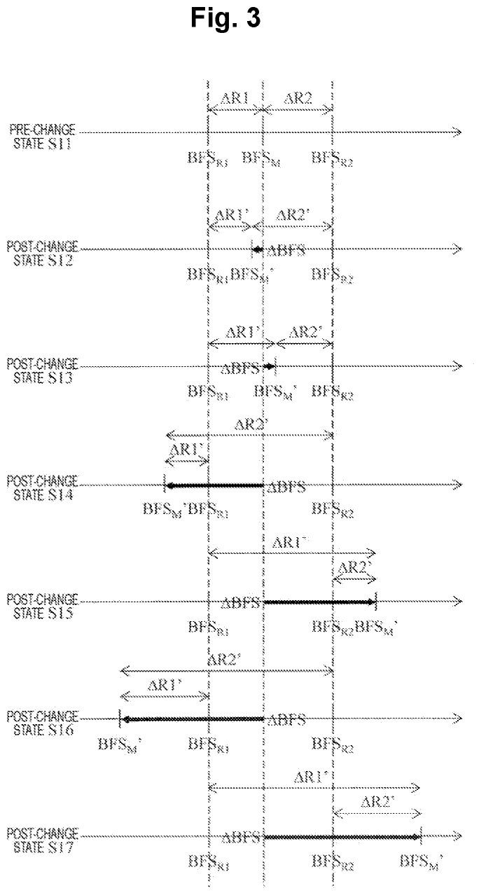

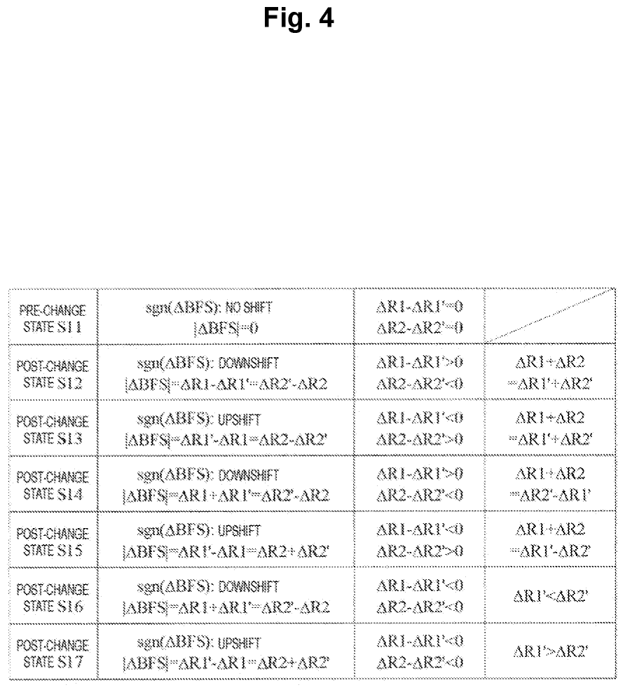

FIGS. 3 and 4 are specific examples of the optical fiber state measurement processing according to the first embodiment. The pre-change state S11 is a steady state of temperature or a non-application state of strain or vibration. The post-change states S12 to S17 are non-steady states of temperature or application states of strain or vibration.

In the pre-change state S11, BFS_{R1}<BFS_{M}<BFS_{R2} is established. The BFS_{M} is located substantially at the center between the BFS_{R1} and the BFS_{R2}. Sgn (ΔBFS) indicates no shift, and |ΔBFS|=0, ΔR1−ΔR1′=0, and ΔR2−ΔR2′=0 are established.

In the post-change state S12, BFS_{M}′ downshifts starting from BFS_{M} with a smaller shift width compared to ΔR1. Sgn (ΔBFS) indicates a downshift, |ΔBFS|=ΔR1−ΔR1′=ΔR2′−ΔR2, ΔR1−ΔR1′>0, and ΔR2−ΔR2′<0 are established, and ΔR1+ΔR2=ΔR1′+ΔR2′ is also established.

In the post-change state S13, BFS_{M}′ upshifts starting from BFS_{M} with a smaller shift width compared to ΔR2. Sgn (ΔBFS) indicates an upshift, |ΔBFS|=ΔR1′−ΔR1=ΔR2−ΔR2′, ΔR1−ΔR1′<0, and ΔR2−ΔR2′>0 are established, and ΔR1+ΔR2=ΔR1′+ΔR2′ is also established.

In the post-change state S14, BFS_{M}′ downshifts starting from BFS_{M} with a larger shift width compared to ΔR1. Sgn (ΔBFS) indicates a downshift, |ΔBFS|=ΔR1+ΔR1′=ΔR2′−ΔR2, ΔR1−ΔR1′>0, and ΔR2−ΔR2′<0 are established, and ΔR1+ΔR2=ΔR1′−ΔR2′ is also established.

In the post-change state S15, BFS_{M}′ upshifts starting from BFS_{M} with a larger shift width compared to ΔR2. Sgn (ΔBFS) indicates an upshift, |ΔBFS|=ΔR1′−ΔR1=ΔR2+ΔR2′, ΔR1−ΔR1′<0, and ΔR2−ΔR2′>0 are established, and ΔR1+ΔR2=ΔR1′−ΔR2′ is also established.

In the post-change state S16, BFS_{M}′ downshifts starting from BFS_{M} with a larger shift width compared to the post-change state S14. Sgn (ΔBFS) indicates a downshift, |ΔBFS|=ΔR1+ΔR1′=ΔR2′−ΔR2, ΔR1−ΔR1′<0, and ΔR2−ΔR2′<0 are established, and ΔR1′<ΔR2′ is also established.

In the post-change state S17, BFS_{M}′ upshifts starting from BFS_{M} with a larger shift width compared to the post-change state S15. Sgn (ΔBFS) indicates an upshift, |ΔBFS|=ΔR1′−ΔR1=ΔR2+ΔR2′, ΔR1−ΔR1′<0, and ΔR2−ΔR2′<0 are established, and ΔR1′>ΔR2′ is also established.

The shift amount change detection unit 15 needs to detect unknown information sgn (ΔBFS) and |ΔBFS| based on the known information ΔR1, ΔR1′, ΔR2, and ΔR2′.

The shift amount change detection unit 15 can detect sgn (ΔBFS)=downshift based on ΔR1−ΔR1′>0 and ΔR2−ΔR2′<0, but cannot detect |ΔBFS| (refer to the post-change states S12 and S14). Therefore, the shift amount change detection unit 15 can detect |ΔBFS|=ΔR1−ΔR1′=ΔR2′−ΔR2 based on ΔR1+ΔR2=ΔR1′+ΔR2′ (refer to the post-change state S12). On the other hand, the shift amount change detection unit 15 can detect |ΔBFS|=ΔR1+ΔR1′=ΔR2′−ΔR2 based on ΔR1+ΔR2=ΔR2′−ΔR1′ (refer to the post-change state S14).

The shift amount change detection unit 15 can detect sgn (ΔBFS)=upshift based on ΔR1−ΔR1′<0 and ΔR2−ΔR2′>0, but cannot detect |ΔBFS| (refer to the post-change states S13 and S15). Therefore, the shift amount change detection unit 15 can detect |ΔBFS|=ΔR1′−ΔR1=ΔR2−ΔR2′ based on ΔR1+ΔR2=ΔR1′+ΔR2′ (refer to the post-change state S13). On the other hand, the shift amount change detection unit 15 can detect |ΔBFS|=ΔR1′−ΔR1=ΔR2+ΔR2′ based on ΔR1+ΔR2=ΔR1′−ΔR2′ (refer to the post-change state S15).

The shift amount change detection unit 15 cannot detect sgn (ΔBFS) based on ΔR1−ΔR1′<0 and ΔR2−ΔR2′<0 (refer to the post-change states S16 and S17). Therefore, the shift amount change detection unit 15 can detect sgn (ΔBFS)=downshift and |ΔBFS|=ΔR1+ΔR1′=ΔR2′−ΔR2 based on ΔR1′<ΔR2′ (refer to the post-change state S16). On the other hand, the shift amount change detection unit 15 can detect sgn (ΔBFS)=upshift and |ΔBFS|=ΔR1′−ΔR1=ΔR2+ΔR2′ based on ΔR1′>ΔR2′ (refer to the post-change state S17).

Note that the shift amount change detection unit 15 may adopt any one of two types of detection values as |ΔBFS|, or may adopt an average value of both detection values to improve accuracy.

### (Specific Example of Optical Fiber State Measurement Processing of Second Embodiment)

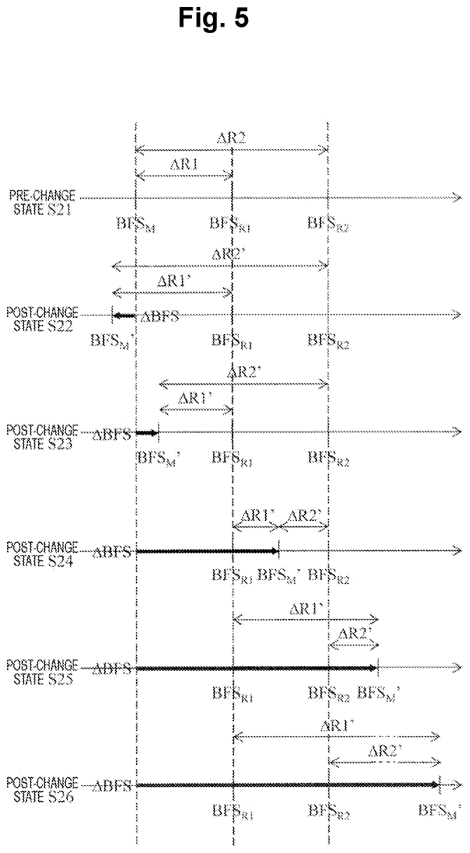

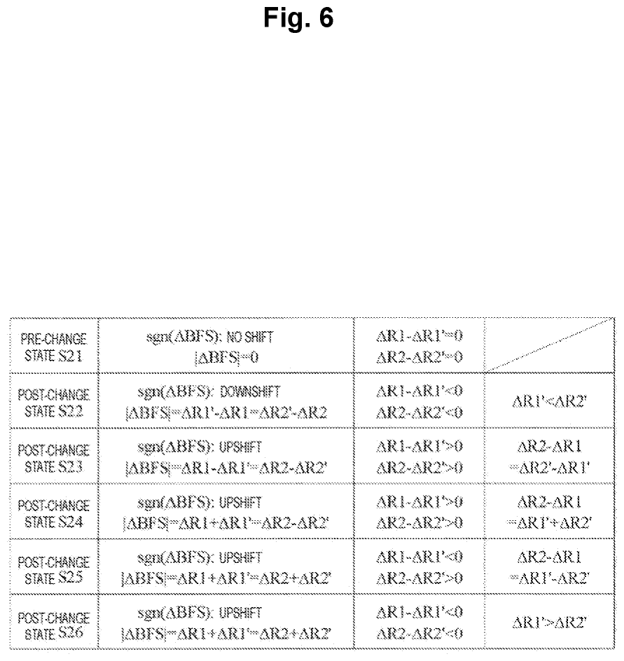

FIGS. 5 and 6 are specific examples of the optical fiber state measurement processing according to the second embodiment. The pre-change state S21 is a steady state of temperature or a non-application state of strain or vibration. The post-change states S22 to S26 are non-steady states of temperature or application states of strain or vibration.

In the pre-change state S21, BFS_{M}<BFS_{R1}<BFS_{R2} is established. The BFS_{R1} is located substantially at the center between the BFS_{M} and the BFS_{R2}. Sgn (ΔBFS) indicates no shift, and |ΔBFS|=0, ΔR1−ΔR1′=0, and ΔR2−ΔR2′=0 are established.

In the post-change state $22, the BFS_{M}′ downshifts by any shift width (regardless of the magnitude relationship with ΔR1 and ΔR2) starting from the BES_{M}. Sgn (ΔBFS) indicates a downshift, |ΔBFS|=ΔR1′−ΔR1=ΔR2′−ΔR2, ΔR1−ΔR1′<0, and ΔR2−ΔR2′<0 are established, and ΔR1′<ΔR2′ is also established.

In the post-change state S23, BFS_{M}′ upshifts starting from BFS_{M} with a smaller/smaller shift width compared to ΔR1/ΔR2. Sgn (ΔBFS) indicates an upshift, |ΔBFS|=ΔR1−ΔR1′=ΔR2−ΔR2′, ΔR1−ΔR1′>0, ΔR2−ΔR2′>0 are established, and ΔR2−ΔR1=ΔR2′−ΔR1′ is also established.

In the post-change state $24, BFS_{M}′ upshifts starting from BFS_{M} with a larger/smaller shift width compared to ΔR1/ΔR2. Sgn (ΔBFS) indicates an upshift, |ΔBFS|=ΔR1+ΔR1′=ΔR2−ΔR2′, ΔR1−ΔR1′>0, ΔR2−ΔR2′>0 are established, and ΔR2−ΔR1=ΔR1′+ΔR2′ is also established.

In the post-change state S25, BFS_{M}′ upshifts starting from BFS_{M} with a larger/larger shift width compared to ΔR1/ΔR2. Sgn (ΔBFS) indicates an upshift, |ΔBFS|=ΔR1+ΔR1′=ΔR2+ΔR2′, ΔR1−ΔR1′<0, ΔR2−ΔR2′>0 are established, and ΔR2−ΔR1=ΔR1′−ΔR2′ is also established.

In the post-change state S26, BFS_{M}′ upshifts starting from BFS_{M} with a much larger/much larger shift width compared to ΔR1/ΔR2. Sgn (ΔBFS) indicates an upshift, |ΔBFS|=ΔR1+ΔR1′=ΔR2+ΔR2′, ΔR1−ΔR1′<0, and ΔR2−ΔR2′<0 are established, and ΔR1′>ΔR2′ is also established.

The shift amount change detection unit 15 needs to detect unknown information sgn (ΔBFS) and |ΔBFS| based on the known information ΔR1, ΔR1′, ΔR2, and ΔR2′.

The shift amount change detection unit 15 can detect sgn (ΔBFS)=upshift based on ΔR1−ΔR1′>0 and ΔR2−ΔR2′ >0, but cannot detect |ΔBFS| (refer to the post-change states S23 and S24). Therefore, the shift amount change detection unit 15 can detect |ΔBFS|=ΔR1′−ΔR1′=ΔR2−ΔR2′ based on ΔR2−ΔR1=ΔR2′−ΔR1′ (refer to the post-change state S23). On the other hand, the shift amount change detection unit 15 can detect |ΔBES|=ΔR1+ΔR1′=ΔR2−ΔR2′ based on ΔR2−ΔR1=ΔR1′+ΔR2′ (refer to the post-change state S24).

The shift amount change detection unit 15 can detect sgn (ΔBFS)=upshift based on ΔR1−ΔR1′<0 and ΔR2−ΔR2′>0, but cannot detect |ΔBFS|=ΔR1+ΔR1′=ΔR2+ΔR2′ (refer to the post-change state S25).

The shift amount change detection unit 15 cannot detect sgn (ΔBFS) based on ΔR1−ΔR1′<0 and ΔR2−ΔR2′<0 (refer to the post-change states S22 and S26). Therefore, the shift amount change detection unit 15 can detect sgn (ΔBFS)=downshift and |ΔBFS|=ΔR1′−ΔR1=ΔR2′−ΔR2 based on ΔR1′<ΔR2′ (refer to the post-change state S22). On the other hand, the shift amount change detection unit 15 can detect sgn (ΔBFS)=upshift and |ΔBES|=ΔR1′+ΔR1=ΔR2+ΔR2′ based on ΔR1′>ΔR2′ (refer to the post-change state S26).

Note that the shift amount change detection unit 15 may adopt any one of two types of detection values as |ΔBFS|, or may adopt an average value of both detection values to improve accuracy.

### (Brillouin Frequency Shift Amount of Reference Optical Fiber)

As described above, it is possible to easily detect the direction, that is, the sign, of the change ΔBFS in the Brillouin frequency shift amount of the optical fiber to be measured M based on the direction, that is, the sign (regardless of the magnitude, that is, the absolute value), of the change in two or more types of beat frequencies from the steady state of temperature or the non-application state of strain or vibration to the non-steady state of temperature or the application state of strain or vibration.

In addition, when determination using the direction, that is, the sign, of the change in the two or more types of beat frequencies described above, is not possible, it is possible to reliably determine the direction, that is, the sign, of the change ΔBFS in the Brillouin frequency shift amount of the optical fiber to be measured M based on the magnitude relationship (regardless of the absolute value of each frequency) between the two or more types of beat frequencies in the non-steady state of temperature or the application state of strain or vibration.

Here, in order to appropriately detect the above-described two types of beat frequencies, the constant Brillouin frequency shift amounts BFS_{R1} and BFS_{R2} of the first reference optical fiber 7 and the second reference optical fiber 9 are appropriately set with respect to the Brillouin frequency shift amount BFS_{M} of the optical fiber to be measured M.

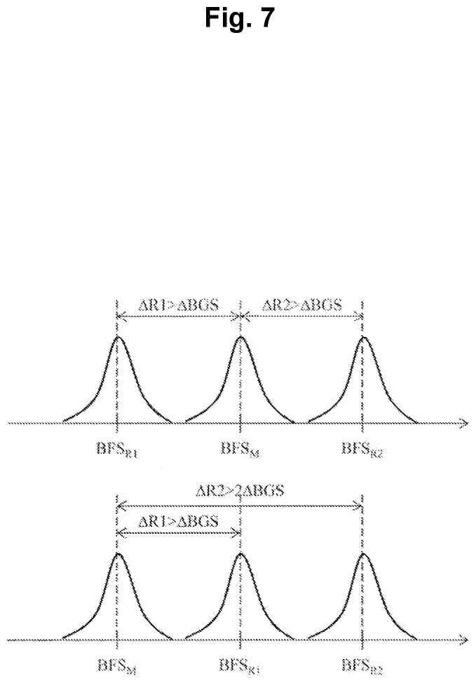

FIG. 7 illustrates Brillouin frequency shift amounts of the first and second reference optical fibers. The constant Brillouin frequency shift amounts BFS_{R1} and BFS_{R2} of the first reference optical fiber 7 and the second reference optical fiber 9 are separated by the Brillouin gain bandwidth ΔBGS or more as compared with the Brillouin frequency shift amount BFS_{M} of the optical fiber to be measured M in the steady state or the non-application state.

In the upper part of FIG. 7, in the first embodiment of FIGS. 3 and 4, BFS_{R1}<BFS_{M}<BFS_{R2} is set, and then ΔR1=|BFS_{M}−BFS_{R1}|>ΔBGS and ΔR2=|BFS_{M}−BFS_{R2}|>ΔBGS are set. In the lower part of FIG. 7, in the second embodiment of FIGS. 5 and 6, BFS_{M}<BFS_{R1}<BFS_{R2} is set, and then ΔR1=|BES_{M}−BFS_{R1}|>ΔBGS and ΔR2=|BFS_{M}−BFS_{R2}|>2ΔBGS are set.

As described above, any beat frequency is less likely to fall to the baseband frequency, and thus can be detected in the order of 100 MHz or 10 MHZ. Here, it is possible to detect the amount of change in the wide range of Brillouin frequency shift amounts as the amount of change ΔBFS in the Brillouin frequency shift amount of the optical fiber to be measured M from the steady state of the temperature or the non-application state of the strain or vibration to the non-steady state of the temperature or the application state of the strain or vibration.

Then, in order to reliably detect the above-described two types of beat frequencies, a constant Brillouin frequency shift amount BFS_{R3} of the third reference optical fiber (not illustrated in FIG. 1) is newly added.

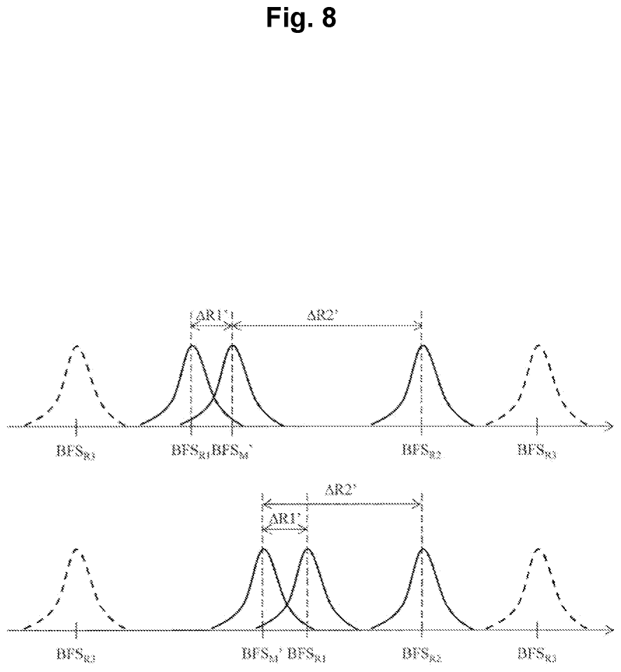

FIG. 8 is a diagram illustrating Brillouin frequency shift amounts of the third reference optical fiber. When clear measurement of the first beat frequency ΔR1′ or the second beat frequency ΔR2′ is not possible in the non-steady state or the application state, the shift amount change detection unit 15 uses the third reference optical fiber having the Brillouin frequency shift amount BFS_{M} in the steady state or the non-application state of the optical fiber to be measured M and the constant Brillouin frequency shift amount BFS_{R3}, which is different from the constant Brillouin frequency shift amounts BFS_{R1} and BFS_{R2} of the first reference optical fiber 7 and the second reference optical fiber 9.

In the upper part of FIG. 8, in the first embodiment of FIGS. 3 and 4, when ΔR1′=|BFS_{M}′−BFS_{R1}|<3 dB bandwidth of the Brillouin scattering spectrum, BFS_{R3}<BFS_{R1} and |BFS_{R3}−BFS_{R1}|>3 dB bandwidth of the Brillouin scattering spectrum are set, and then ΔR3′=|BFS_{M}′−BFS_{R3}|>3 dB bandwidth of the Brillouin scattering spectrum may be set. On the other hand, in the first embodiment of FIGS. 3 and 4, when ΔR2′=|BFS_{M}′−BFS_{R2}|<3 dB bandwidth of the Brillouin scattering spectrum, BFS_{R3}>BFS_{R2} and |BFS_{R3}−BFS_{R2}|>3 dB bandwidth of the Brillouin scattering spectrum are set, and then ΔR3′=|BFS_{M}′−BFS_{R3}|>3 dB bandwidth of the Brillouin scattering spectrum may be set.

In the lower part of FIG. 8, in the second embodiment of FIGS. 5 and 6, when ΔR1′=|BFS_{M}′−BFS_{R1}|<3 dB bandwidth of the Brillouin scattering spectrum, BFS_{R3}<BFS_{R1} and |BFS_{R3}−BFS_{R1}|>3 dB bandwidth of the Brillouin scattering spectrum are set, and then ΔR3′=|BFS_{M}′−BFS_{R3}|>3 dB bandwidth of the Brillouin scattering spectrum may be set. On the other hand, in the second embodiment of FIGS. 5 and 6, when ΔR2′=|BFS_{M}′−BFS_{R2}|<3 dB bandwidth of the Brillouin scattering spectrum, BFS_{R3}>BFS_{R2} and |BFS_{R3}−BFS_{R2}|>3 dB bandwidth of the Brillouin scattering spectrum are set, and then ΔR3′=|BFS_{M}′−BFS_{R3}|>3 dB bandwidth of the Brillouin scattering spectrum may be set.

As described above, even when any beat frequency falls to the baseband frequency, the beat frequency in place of the beat frequency is less likely to fall to the baseband frequency, and thus can be detected in the order of 100 MHz or 10 MHz. Here, it is possible to detect the amount of change in the wide range of Brillouin frequency shift amounts as the amount of change ΔBFS in the Brillouin frequency shift amount of the optical fiber to be measured M from the steady state of the temperature or the non-application state of the strain or vibration to the non-steady state of the temperature or the application state of the strain or vibration.

### INDUSTRIAL APPLICABILITY

The optical fiber state measurement device and the optical fiber state measurement method of the present disclosure can simplify the device configuration of the optical fiber state measurement while eliminating the need for a wideband light receiving device in measuring the temperature change, strain change, or vibration state of the optical fiber to be measured.

In general, since a change in the Brillouin frequency shift amount is detected while sequentially changing the test light frequency, particularly, it is not possible to measure a phenomenon with a fast change such as a vibration phenomenon. In the present disclosure, since the change in the Brillouin frequency shift amount is detected only by monitoring the beat frequency, particularly, it is possible to particularly measure a phenomenon with a fast change such as a vibration phenomenon.

### REFERENCE SIGNS LIST

D Optical fiber state measurement device
M Optical fiber to be measured
1 Light source
2 Branching unit
3 Pulsing unit
4 Circulator
5 Branching unit
6 Circulator
7 First reference optical fiber
8 Circulator
9 Second reference optical fiber
10 Branching unit
11 Multiplexing unit
12 First beat frequency detection unit
13 Multiplexing unit
14 Second beat frequency detection unit
15 Shift amount change detection unit

1. An optical fiber state measurement device that measures temperature, strain, or vibration of an optical fiber to be measured, the optical fiber state measurement device comprising:
a first reference optical fiber and a second reference optical fiber that have an optical fiber length longer than that of the optical fiber to be measured, have a constant Brillouin frequency shift amount different from that of the optical fiber to be measured in a steady state of temperature or a non-application state of strain or vibration with respect to the same incident wavelength, and have constant Brillouin frequency shift amounts different from each other with respect to the same incident wavelength;
a test light incidence unit that causes pulsed measurement test light to be incident on the optical fiber to be measured, and causes continuous light having the same wavelength as the measurement test light or pulsed first reference test light and pulsed second reference test light to be incident on the first reference optical fiber and the second reference optical fiber;
a scattered light input unit into which pulsed measurement Brillouin scattered light is input from the optical fiber to be measured, and into which continuous light or pulsed first reference Brillouin scattered light and second reference Brillouin scattered light are input from the first reference optical fiber and the second reference optical fiber;
a beat frequency detection unit that multiplexes the measurement Brillouin scattered light and the first reference Brillouin scattered light to detect a first beat frequency thereof, and multiplexes the measurement Brillouin scattered light and the second reference Brillouin scattered light to detect a second beat frequency thereof; and
a shift amount change detection unit that detects a direction, that is, a sign, of a change in a Brillouin frequency shift amount of the optical fiber to be measured from the steady state or the non-application state to a non-steady state or an application state based on the first beat frequency and the second beat frequency in a steady state of a temperature or a non-application state of strain or vibration of the optical fiber to be measured and in the non-steady state of a temperature or the application state of strain or vibration of the optical fiber to be measured.

2. The optical fiber state measurement device according to claim 1, wherein
the shift amount change detection unit detects a direction of a change in a Brillouin frequency shift amount of the optical fiber to be measured from the steady state or the non-application state to the non-steady state or the application state based on a direction of a change in the first beat frequency and a direction of a change in the second beat frequency from the steady state or the non-application state to the non-steady state or the application state.

3. The optical fiber state measurement device according to claim 2, wherein
when a direction of a change cannot be determined in claim 2, the shift amount change detection unit determines a direction of a change in a Brillouin frequency shift amount of the optical fiber to be measured from the steady state or the non-application state to the non-steady state or the application state based on a magnitude relationship between the first beat frequency and the second beat frequency in the non-steady state or the application state.

4. The optical fiber state measurement device according to claim 1, wherein
the shift amount change detection unit detects a magnitude, that is, an absolute value of a change in a Brillouin frequency shift amount of the optical fiber to be measured from the steady state or the non-application state to the non-steady state or the application state based on the first beat frequency and the second beat frequency in the steady state or the non-application state and in the non-steady state or the application state.

5. The optical fiber state measurement device according to claim 1, wherein
constant Brillouin frequency shift amounts of the first reference optical fiber and the second reference optical fiber, which are different from each other, are separated from each other by a Brillouin gain bandwidth or more as compared with a Brillouin frequency shift amount of the optical fiber to be measured in the steady state or the non-application state.

6. The optical fiber state measurement device according to claim 1, wherein
when clear measurement of the first beat frequency or the second beat frequency is not possible in the non-steady state or the application state, the shift amount change detection unit uses a third reference optical fiber having a Brillouin frequency shift amount in the steady state or the non-application state of the optical fiber to be measured and a constant Brillouin frequency shift amount different from constant Brillouin frequency shift amounts of the first reference optical fiber and the second reference optical fiber, which are different from each other.

7. An optical fiber state measurement method for measuring temperature, strain, or vibration of an optical fiber to be measured, the optical fiber state measurement method comprising, in order:
by using a first reference optical fiber and a second reference optical fiber that have an optical fiber length longer than that of the optical fiber to be measured, have a constant Brillouin frequency shift amount different from that of the optical fiber to be measured in a steady state of temperature or a non-application state of strain or vibration with respect to the same incident wavelength, and have constant Brillouin frequency shift amounts different from each other with respect to the same incident wavelength,
a test light incidence step of causing pulsed measurement test light to be incident on the optical fiber to be measured, and causing continuous light having the same wavelength as the measurement test light or pulsed first reference test light and pulsed second reference test light to be incident on the first reference optical fiber and the second reference optical fiber;
a scattered light input step in which pulsed measurement Brillouin scattered light is input from the optical fiber to be measured, and continuous light or pulsed first reference Brillouin scattered light and second reference Brillouin scattered light are input from the first reference optical fiber and the second reference optical fiber;
a beat frequency detection step of multiplexing the measurement Brillouin scattered light and the first reference Brillouin scattered light to detect a first beat frequency thereof, and multiplexing the measurement Brillouin scattered light and the second reference Brillouin scattered light to detect a second beat frequency thereof; and
a shift amount change detection step of detecting a direction, that is, a sign, of a change in a Brillouin frequency shift amount of the optical fiber to be measured from the steady state or the non-application state to a non-steady state or an application state based on the first beat frequency and the second beat frequency in a steady state of a temperature or a non-application state of strain or vibration of the optical fiber to be measured and in the non-steady state of a temperature or the application state of strain or vibration of the optical fiber to be measured.
